(19) United States
(12) Patent Application Publication
(10) Pub. No.: US 2002/0106137 A1
(43) Pub. Date: Aug. 8, 2002

(54) Image capture device with a boundary indicator

(76) Inventors: Kun-Chou Chen, Taipei (TW); In-Ming Hwang, Miao Li Hsien (TW); Yung-Che Chang, Taipei (TW)

Correspondence Address: BAKER & BOTTS, 30 ROCKEFELLER PLAZA, NEW YORK, NY, 10112

(21) Appl. No.: 09/993,012

(22) Filed: Nov. 14, 2001

(30) Foreign Application Priority Data
Feb. 6, 2001 (TW) 90102555

(51) Int. Cl. G06K 7/10; G06K 9/20

(52) U.S. Cl. 382/321

(57) ABSTRACT

An image capture device has an image sensor, a cone, a support arm, a base and an indicator. The image sensor, assembled within the cone, is utilized to capture an image of an object and generate an image signal thereof, while the support arm connects the cone and the base. The indicator comprises at least one lamp assembled within the rim of the cone for emitting light to demarcating an image capture area of the image capture device.

### FIELD OF THE INVENTION

This invention relates to an image capture device, and specifically relates to an image capture device with a boundary indicator.

### BACKGROUND OF THE INVENTION

Since optical projecting systems have been developed, they have been widely utilized in many industrial applications, such as projectors for entertainment or business equipment, to project and to display enlarged images on a screen. Among optical projecting systems, an object projector is very convenient for use because the subject to be projected is not limited to planner projection sheets but can be any real object. In other words, any document or object is placed in front of the object projector so that corresponding images can be clearly shown on a display device, with an enlarged image thereof, via the object projector.

In general, a conventional object projector is a device utilized for capturing images of documents or objects and usually comprises a fixed table indicating a general area where documents or objects can be placed. However, a problem occurs when the projector is being operated because a proper projecting location whereon a user may precisely place documents or objects is not shown. The user must correct the location of documents or objects repeatedly with reference to actual images displayed until a proper projecting location has been found. In unfavorable situations, adjusting the position of the document or the object backward and forward within the limits of the fixed table of the projector takes a lot of time.

Analysis of the drawbacks of the above conventional projector show that the adjustment problem is largely due to an inability of the fixed table to indicate the area in which proper image capture is possible. More particularly, if the projector comprises “zoom in” and “zoom out” functions, the image capture area changes correspondingly. In such a case, the problem of finding a proper image capture area effectively and quickly worsens.

In additional, the fixed table of the projector is usually large in size. It is not convenient to carry the projector with the table. If the user carries the projector without the table for convenience, a general image capture position cannot be indicated at all. Accordingly, the design of the table for the portable projector is not appropriate.

In other words, the conventional projector cannot effectively indicate the precise image capture area and thus adversely affects fluency of a meeting or a report in progress. Therefore, it is crucial to improve the efficiency of a traditional projector's operation for easily and effectively capturing images of documents or objects.

### SUMMARY OF THE INVENTION

It is an object of this invention to provide an image capture device to show a clear area or range of area to capture an object's or a document's image.

It is another object of this invention to provide an image capture device with a boundary indicator for effectively demarcating an image capture area of the image capture device.

This invention discloses a projector or an image capture device, comprising an image sensor, a cone, a support arm, a base and an indicator. The image sensor, assembled within the cone, is utilized to capture an image of an object and generate an image signal thereof, while the support arm connects between with the cone and the base. Particularly, the indicator comprises at least one lamp assembled within the rim of the cone for emitting light to effectively demarcate an image capture area of the image capture device.

### BRIEF DESCRIPTION OF THE DRAWINGS

FIGS. 1A-B schematically illustrates main components of an image capture device of the present invention.

FIGS. 2A-B schematically illustrates an image capture area demarcated by an indicator of an image capture device of the present invention.

### DETAILED DESCRIPTION OF THE PREFERRED EMBODIMENT

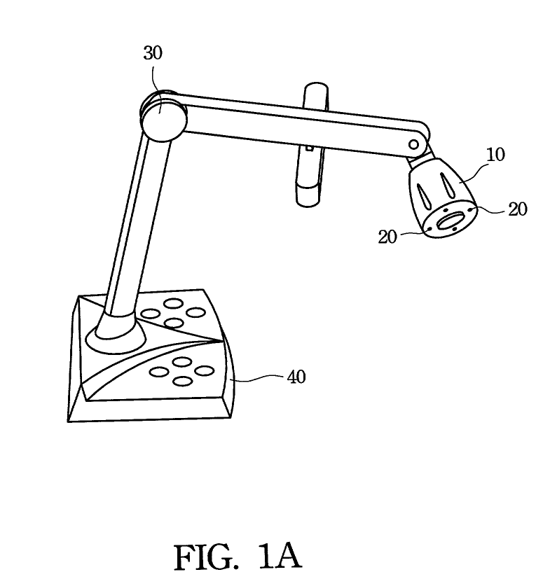

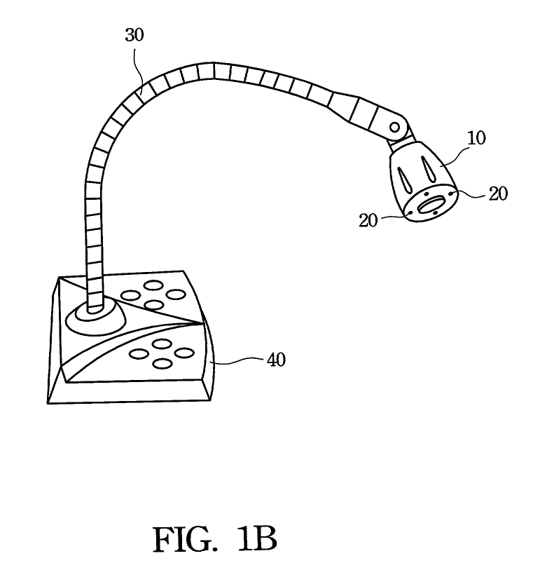

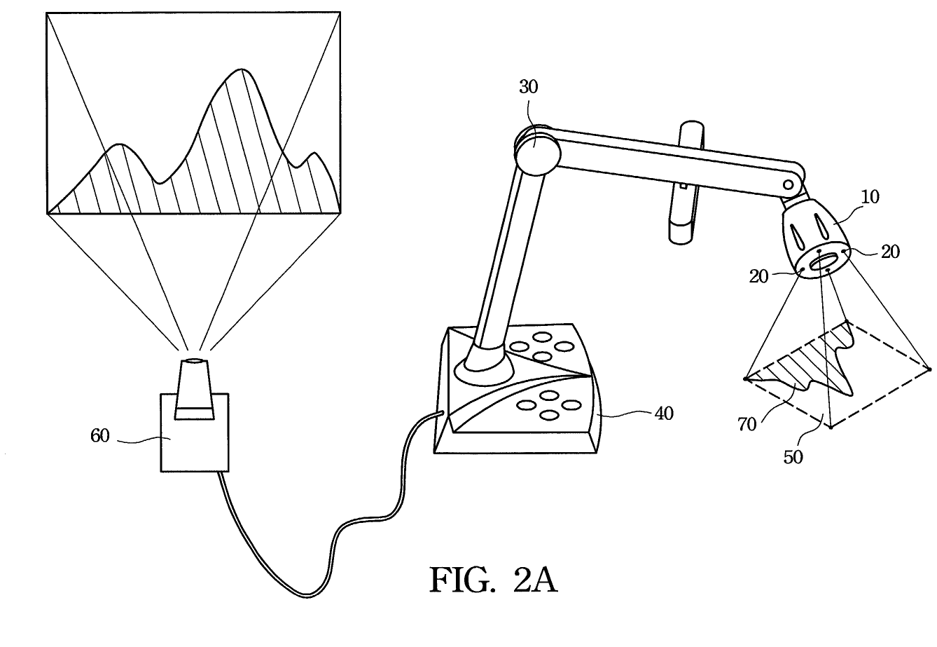

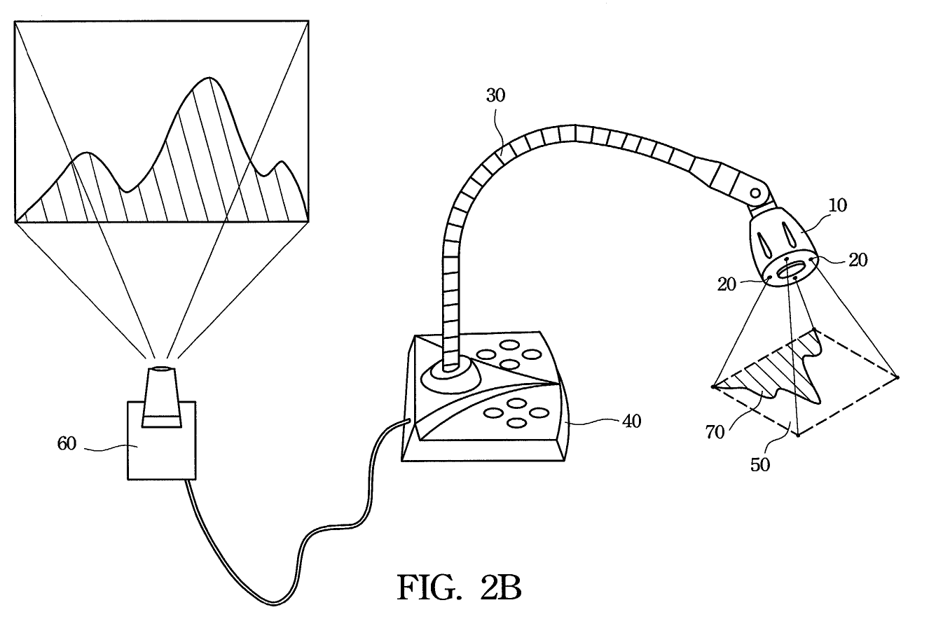

The present invention is about a boundary indicator applied to an image capture device for quickly and precisely demarcating an area as the image capture device projects images of documents or objects on a screen. As illustrated in FIGS. 1A-B, main components of the image capture device of the present invention include a cone 10, a boundary indicator 20, a support arm 30 and a base 40. Specifically, there is an image sensor (not shown) inside the cone 10 for capturing images of documents or objects and generating a signal therefor. The image sensor may be, for example, a charge coupled device (CCD) or a complementary metal-oxide semiconductor (CMOS). In additional, one end of the support arm 30 connects with the cone 10, and moreover, a signal transmission component inside the support arm 30 is coupled with the image sensor for transmitting those signals to display device 60. Display device 60 is, for example, a screen, monitor, or other projector, as shown in FIG. 2A-B. The signal transmission component may further connect to a recording device, such as RAM, to record directly those signals. More specifically, the support arm 30 may be a robot arm, as illustrated in FIG. 1A, or the arm 30 may comprise a plastic surface, as illustrated in FIG. 1B, for flexibly adjusting the distance between the arm 30 and the object being projected for the purpose of “zoom in” and “zoom out” effects. The other end of the support arm 30 connects with the base 40. Base 40 carries the whole weight of the main components of the image capture device of the present invention.

One main feature of the image capture device of the present invention is the boundary indicator 20. This indicator 20 is generally assembled outside the cone 10 to provide the user with a clear and precise image capture area for the image capture device. Thus the user can easily find the boundaries of the image capture area without wasting time to correct the projecting position of w documents or objects. More specifically, the indicator comprises at least one lamp assembled within the rim of the cone's bottom. The lamp is able to illuminate the surface on which the documents or the objects 70 are placed to demarcate the image capture area 50 as illustrated in FIGS. 2A-B. In a preferred embodiment of the present invention, the lamp is a laser illuminator for a better illumination demarcating the image capture area 50. Moreover, in another embodiment of the present invention, four lamps may be assembled along the circumference of the rim of the cone 10 to clearly indicate the corresponding four corners of the image capture area 50. Once the four corners of the image capture area 50 are indicated, the user can easily and quickly find the precise location in which the documents or the objects 70 should be placed. More particularly, the user can properly move the documents or the objects 70 to anywhere the user desires within the image capture area 50 with a reference to the area that the indicator 20 indicates. Accordingly, the problem of moving the documents or the objects 70 outside the image capture area 50 of the projector or the image capture device, as described in the background, can be solved. It should be noted that the indicator 20 of the present invention is not limited to four lamps, assembled within the rim of the cone 10. Any proper location of the cone 10 with proper lamp quantity can be regarded as falling within the spirit and scope of the present invention.

The support arm 30 of the present invention can be moved in all directions to adjust the distance between the documents or the objects 70 and the cone 10 in cooperation with enlarging or shrinking images of the documents or the objects 70. The image capture area 50, which the indicator 20 indicates, also becomes larger or smaller in proportion to the ratio of image enlarging or shrinking according to the “zoom in ” or “zoom out” function of the image capture device. Therefore, the image capture area 50 can be indicated flexibly to help the user place the documents or the objects 70 precisely and quickly without any guessing about the proper position for projection.

Furthermore, the image capture device of the invention does not need the fixed table of the traditional projector. Without the fixed table, the image capture device of the invention can also easily demarcate an image capture area 50 thereof with the boundary indicator 20. The surface, onto which the boundary indicator 20 emits light, is not limited to a horizontal surface. A curved surface may be utilized by the indicator 20 of this invention. As a result, the image capture device of the invention can be further applied to project images of a 3-dimensional object and broaden the traditional projector's application.

Although the invention has been described in detail herein with reference to its preferred embodiment, it is to be understood that this description is by way of example only, and is not to be construed in a limiting sense. It is to be further understood that numerous changes in the details of the embodiments of the invention, and additional embodiments of the invention, will be apparent to, and may be made by, persons of ordinary skill in the art having reference to this description. It is contemplated that such changes and additional embodiments are within the spirit and true scope of the invention as claimed below.

What is claimed is:

1. An image capture device, comprising an image sensor, for capturing an image of an object and generating an image signal, a cone holding said image sensor, a support arm connected to said cone, a signal transmission component coupled to said image sensor for transmitting said image signal, and a base connected to said support arm for carrying said image capture device, characterized in that
an indicator means, mounted on said cone, for effectively demarcating an image capture area of said image capture device.

2. The device as recited in claim 1, wherein said image sensor further comprises a charge coupled device (CCD).

3. The device as recited in claim 1, wherein said image sensor further comprises a complementary metal-oxide semiconductor (CMOS).

4. The device as recited in claim 1, wherein said indicator means further comprises at least one lamp assembled within a rim of said cone for emitting light to demarcate the image capture area.

5. The device as recited in claim 4, wherein said lamp is a laser illuminator.

6. The device as recited in claim 4, wherein said at least one lamp further comprises four lamps assembled along a circumference of the rim of said cone for demarcating four corners of the image capture area.

7. The device as recited in claim 1, wherein said support arm further comprises a robot arm for flexibly adjusting the image capture area.

8. The device as recited in claim 1, wherein said support arm further comprises a plastic surface for flexibly adjusting the image capture area.

9. An image capture device, comprising an image sensor for capturing an image of an object and generating image signal, a cone holding said image sensor, a support arm connected to said cone, a signal transmission component coupled to said image sensor for transmitting said image signal and a base connected to said support arm for carrying said image capture device, characterized in that
at least one lamp, assembled in a rim of said cone for emitting light to demarcate an image capture area of said image capture device.

10. The device as recited in claim 9, wherein said image sensor further comprises a charge coupled device (CCD).

11. The device as recited in claim 9, wherein said image sensor further comprises a complementary metal-oxide semiconductor (CMOS).

12. The device as recited in claim 9, wherein said lamp is a laser illuminator.

13. The device as recited in claim 9, wherein said at least one lamp further comprises four lamps assembled along a circumference of the rim of said cone for demarcating four corners of the image capture area.

14. The device as recited in claim 9, wherein said support arm further comprises a robot arm for flexibly adjusting the image capture area.

15. The device as recited in claim 9, wherein said support arm further comprises a plastic surface for flexibly adjusting the image capture area.
